(19) United States
(12) Patent Application Publication
(10) Pub. No.: US 2026/0153859 A1
(43) Pub. Date: Jun. 4, 2026

(54) System and Method for Matching and Optimizing Process Systems Using Digital Twins and Neural Network

(71) Applicant: Yang Pan, SINGAPORE (SG)

(72) Inventor: Yang Pan, SINGAPORE (SG)

(73) Assignee: Inspiring Atoms Pte Ltd, SINGAPORE (SG)

(21) Appl. No.: 18/964,345

(22) Filed: Nov. 29, 2024

(51) Int. Cl. G05B 19/418

(52) U.S. Cl. CPC G05B 19/41875; G05B 19/41885

(57) ABSTRACT

Disclosed herein is a method for matching process systems in semiconductor manufacturing by utilizing digital twins and neural networks. Digital twins of individual and group process systems are constructed, with the group digital twin guiding the matching of process systems within the group. Neural networks, trained on simulation and measured data, enhance computational efficiency, enabling precise matching and compatibility.

### FIELD OF THE INVENTION

This invention pertains to the field of semiconductor manufacturing, focusing on advanced process system management and optimization techniques. It specifically addresses the critical need for precise matching and calibration of groups of process systems.

### BACKGROUND OF THE INVENTION

In the semiconductor industry, the increasing complexity of processing technologies and the demand for atomic layer control precision have amplified the need for sophisticated process system management solutions. As semiconductor fabrication processes evolve toward finer geometries and more intricate structures, the margin for error narrows significantly. This evolution underscores the importance of achieving precise matching of process systems to ensure uniformity and high-quality output across different manufacturing tools and platforms.

Conventional methods of process system management in semiconductor manufacturing often fail to meet the stringent requirements of modern fabrication processes. These traditional approaches typically rely on general specifications and parameters that may not adequately account for the unique characteristics and variabilities of individual process systems. This inadequacy can result in processing inconsistencies, reduced yield, and increased operational costs due to inefficiencies and frequent manual interventions.

Moreover, the increasing complexity of semiconductor processing demands a more dynamic approach to system calibration and optimization. This includes the ability to integrate new process systems seamlessly into existing fabrication lines and recalibrate systems exhibiting operational anomalies, as identified through in-situ sensors or post-processing metrology. Current process system management methodologies lack the necessary flexibility and intelligence to adapt to the specific needs of each system while maintaining overall operational consistency.

There is a pressing need for a method that can intelligently match and calibrate process systems with high precision and adaptability, addressing the individual operational nuances of each system. Such a method would significantly enhance the efficiency and output quality of semiconductor manufacturing processes, addressing the challenges posed by the industry's progression toward more complex and precise fabrication techniques.

This invention addresses this gap by introducing a novel method that leverages digital twins and neural networks for advanced process system matching and optimization. It is tailored to meet the semiconductor industry's demanding requirements, ensuring precise control and uniformity in complex fabrication processes.

### SUMMARY

The method described herein provides a comprehensive approach to process system matching within a group of process systems, employing advanced digital twins and neural networks. It ensures operational consistency and optimization across diverse process environments with adaptability and precision.

Central to this method is a group-system digital twin, which encapsulates the collective characteristics and performance metrics of a group of process systems. This digital twin serves as a pivotal reference model, providing a benchmark against which individual process systems are evaluated. It ensures alignment with established standards, maintaining uniformity in performance and quality.

Each process system within the group is represented by a process system-specific digital twin. This detailed representation captures the unique characteristics and operational parameters of an individual process system, enabling nuanced assessment and optimization tailored to each system while ensuring compliance with group standards.

A notable feature of this method is its versatility. In some embodiments, the system-specific parameters of a selected process system are meticulously compared against the group-system digital twin. This comparison extends beyond parameter-level assessments to evaluate the overall operational fit of the process system within the group. The method can autonomously generate a process recipe using the system-specific parameters, validating compatibility with the group and enhancing operational efficiency through tailored optimization.

This method is particularly advantageous for integrating new process systems into existing groups and evaluating systems exhibiting abnormalities, as identified through measured data generated from a measurement engine. This adaptability ensures high standards of efficiency and consistency across process system operations.

Digital twin development in this methodology employs a bottom-up approach, encompassing a comprehensive range of subsystems such as radio frequency (RF), gas distribution, and temperature control. This ensures detailed and effective representation of each subsystem, contributing to the creation of accurate process system-specific digital twins.

By combining detailed insights from digital twins with the computational efficiency of neural networks, this method offers a sophisticated approach to process system matching. It enhances consistency across system groups, optimizes individual system performance, and ensures overall system efficiency, reliability, and adaptability.

### BRIEF DESCRIPTIONS OF THE DRAWINGS AND TABLES

To enhance clarity, the following descriptions reference the accompanying drawings and tables:

FIG. 1A: Diagram of an exemplary process system using atomic layer etching (ALE) as an example, illustrating key components and their configurations.

FIG. 1B: Functional diagram of a system controller for control of an ALE process, highlighting operational logic and control mechanisms.

FIG. 2A: Timing diagram of various steps in an ALE process, exemplified in different plasma states.

FIG. 2B: Timing diagram of an ALE process during gas exchange steps.

FIG. 2C: Schematic representation of an exemplary structure before and after the ALE process.

FIG. 3: Schematic representation of a system digital twin for an ALE process.

FIG. 4: Neural network representation of the system digital twin.

FIG. 5: Flowchart outlining the training protocol for a digital twin of the ALE system, utilizing various neural networks.

FIG. 6A: Procedural flowchart for determining resonant frequencies using trained neural network models.

FIG. 6B: Flowchart detailing vacuum valve setpoint determination guided by neural network-based predictions.

FIG. 6C: Procedural diagram for establishing heating and cooling parameters through neural network-derived setpoints.

FIG. 7: Diagram of a group of process systems installed across a fleet of tools.

FIG. 8A: Schematic diagram of an exemplary group-subsystem neural network, including chamber-specific subsystem neural networks.

FIG. 8B: Diagram of an inverse group-subsystem neural network, illustrating its inputs and outputs.

FIG. 9A: Flowchart describing generating the statistical distribution of subsystem outputs using the group-subsystem digital twin.

FIG. 9B: Flowchart describing a training process of an inverse group-subsystem neural network using the data generated by the group-subsystem neural network.

FIG. 10A: Schematic diagram of an inverse neural network for generating chamber-specific parameters for a new process system.

FIG. 10B: Schematic diagram of constructing a chamber-specific subsystem neural network for a new chamber.

FIG. 11A: Flowchart for constructing a group-system neural network, using an ALE process system as an example.

FIG. 11B: Flowchart for constructing a process system neural network for a new process system, using an ALE process system as an example.

FIG. 12A: Flowchart for a first embodiment of a method for determining if a process system exhibits abnormalities.

FIG. 12B: Flowchart for a second embodiment of a method for determining if a process system exhibits abnormalities.

Table 1: Parameters describing structures to be etched and their post-ALE processing states.

Table 2: Parameters describing process recipe details.

### DETAILED DESCRIPTIONS

In this section, we delve into the specific embodiments of the current invention to facilitate a deeper understanding. It should be noted that while implementations are described for clarity, alterations and modifications falling within the scope of the claims that follow are considered to be within the ambit of this disclosure. The detailed descriptions are intended to highlight the novel aspects of the invention, distinguishing it from conventional technology.

### Definition

### ALE (Atomic Layer Etching):

A plasma-based etching technique that removes material from a substrate layer by layer through alternating steps of surface modification and sputtering.

### Process Recipe:

A defined set of steps, conditions, and durations used in semiconductor manufacturing processes, including surface modification, sputtering, deposition, and other optional steps.

### Recipe Parameters:

Variables that define the specifics of a process recipe, including cycle counts, gas flow rates, RF power settings, substrate temperatures, and optional deposition timings.

### Subsystem Control Parameters:

Operational settings for individual subsystems, such as RF resonant frequencies, vacuum valve positions, heater and chiller setpoints, and gas flow rates.

### System Digital Twin:

A comprehensive virtual model of a semiconductor manufacturing system, simulating interactions across all subsystems to predict process outcomes and enable real-time control.

### Reactor Digital Twin:

A subset of the system digital twin, integrating subsystems such as RF, gas, temperature, and plasma models to predict ion and neutral fluxes, substrate surface temperatures, and overall plasma dynamics.

### Chamber Plasma Digital Twin:

A component of the reactor digital twin simulating plasma dynamics, including electron, ion, and neutral particle distributions, plasma sheath properties, and plasma interactions.

### RF Digital Twin:

A model of the RF subsystem, including power generators, resonators, and plasma source components, used to optimize RF power delivery, impedance matching, and plasma initiation.

### Gas Digital Twin:

A model simulating gas flow dynamics, including inflow, outflow, chamber conductance, and pressure regulation based on gas flow rates, vacuum valve positions, and chamber geometry.

### Temperature Digital Twin:

A model simulating thermal behavior within the process chamber, including substrate temperature, heater and chiller dynamics, and thermal conduction through the chuck.

### Chamber Surface Digital Twin:

A model capturing changes in chamber surfaces caused by plasma exposure, such as erosion, composition changes, and surface roughness, and their effects on process performance.

### Substrate Edge Digital Twin:

A model focusing on edge-specific behavior, accounting for plasma, gas flow, and thermal variations affecting uniformity and edge ring wear.

### Process Digital Twin:

A model simulating the evolution of substrate structures during process steps, incorporating recipe parameters, material properties, and structural transformations.

### Group System Digital Twin:

A digital twin representing a group of process systems, capturing statistical distributions of parameters across systems and enabling group-wide optimization.

### Group Subsystem Digital Twin:

A digital twin composed of multiple subsystem-specific models for a group of process systems, allowing statistical evaluation of individual subsystem behavior.

### Group Subsystem Neural Network:

A neural network derived from the group-subsystem digital twin, trained to predict statistical distributions and variability across subsystems in a group.

### Group-System Neural Network:

A neural network based on the group-system digital twin, used for real-time evaluation and optimization of process systems at the group level.

### Neural Network:

A computational model trained on simulated and measured data, capable of replicating digital twin behavior to enable rapid, real-time predictions.

### Subsystem Neural Networks:

Neural networks trained for individual subsystems, such as RF, gas, temperature, or chamber surfaces, enhancing predictive accuracy and real-time control.

### System Neural Network:

A neural network derived from the system digital twin, providing a holistic representation of the entire process system for real-time prediction and optimization.

### Inverse Neural Network:

A neural network trained to infer subsystem-specific or process-system-specific parameters from input parameters and observed outputs.

### Group Subsystem Inverse Neural Network:

An inverse neural network trained using group-subsystem digital twin data to infer parameters for subsystems in a group of process systems.

### Measurement Engine:

A component of the system controller that gathers real-time data, such as optical critical dimension (CD) measurements, to refine digital twin models and dynamically adjust process parameters.

### Plasma Sheath:

The boundary layer near chamber surfaces where ions are accelerated toward the substrate, crucial for controlling surface modification and sputtering processes.

### Ion and Neutral Fluxes:

The flow of ions and neutral particles toward the substrate surface, determining etching or deposition dynamics in plasma-based processes.

### Plasma Impedance:

A parameter representing the resistance of plasma to RF power, critical for optimizing power delivery and impedance matching.

### Cost Function:

A mathematical function evaluating process performance by comparing predicted outputs to target specifications, used to guide optimization.

### Statistical Distribution:

A representation of variability in subsystem parameters or outputs across a group of process systems, used to identify deviations and guide adjustments.

### Deviation Function:

A function comparing current process-specific parameters to nominal values, factoring in weighting to identify and quantify problematic parameters.

### Edge Ring:

A consumable component near the substrate edge in the process chamber, susceptible to wear from plasma exposure and critical for maintaining uniformity.

### Optimization Procedure:

A method leveraging digital twins or neural networks to iteratively adjust parameters and refine process recipes for improved performance.

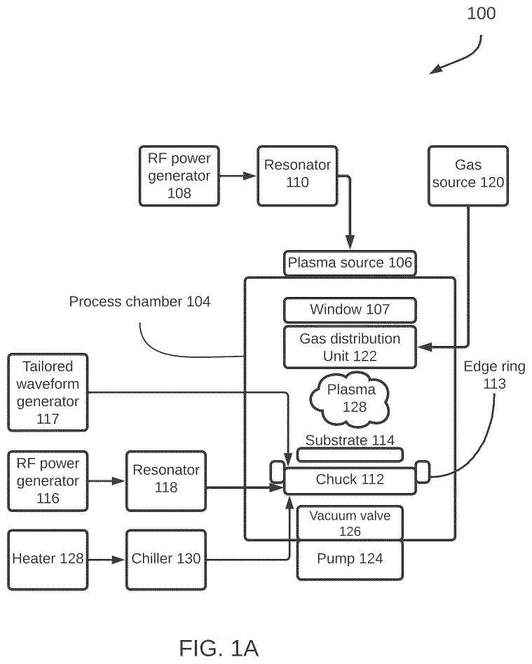

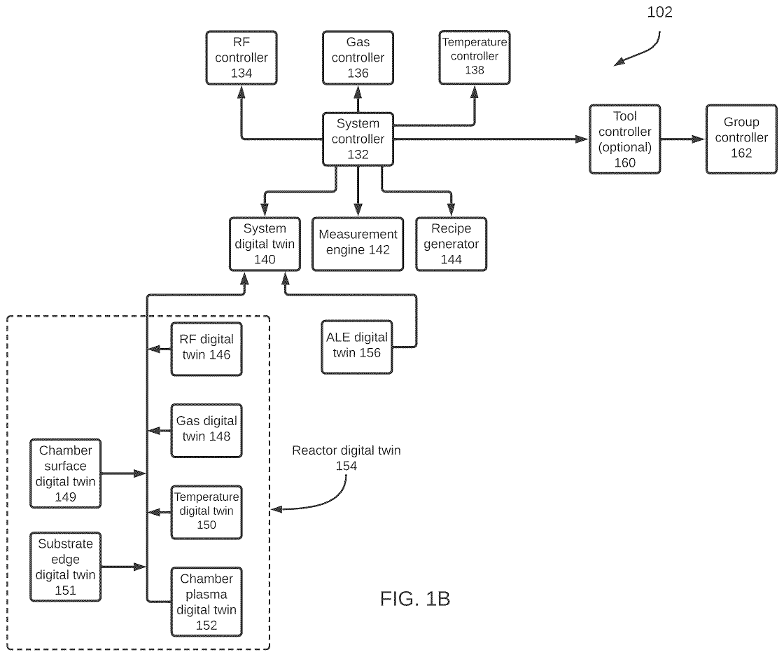

FIG. 1A illustrates an exemplary embodiment of an ALE process system, designated broadly at 100A. The ALE system is employed as an example to illustrate the present inventive concept without limiting its scope to other similar process systems, such as a reactive ion etching (RIE) system, a plasma-enhanced chemical vapor deposition (PECVD) system, an atomic layer deposition (ALD) system, a thermal etching system, or a thermal deposition system. The ALE system 100A comprises a process chamber 104, designed to maintain a vacuum suitable for plasma processing. Within this system, a plasma source 106 is configured to receive radio frequency (RF) power from an RF power generator 108 via a resonator 110. The plasma source 106 may take various forms, including but not limited to an inductively coupled plasma (ICP) source or a transformer coupled plasma (TCP) source.

The RF power generator 108 can operate at single or multiple frequencies, such as 13.56 MHz and/or 2.0 MHz. The resonator 110 plays a critical role in matching the output impedance of the RF generator 108 to the impedance of the plasma process chamber 104, accounting for the impedance characteristics of the transmission lines. This resonator 110 is typically constructed from inductors and capacitors and may, in some configurations, include mechanically adjustable capacitors. Alternatively, in some embodiments, the resonator 110 may exclude mechanically adjustable capacitors. Impedance adjustments can be achieved by varying the operating frequencies of the RF power generator 108 and the resonator 110. During the ALE process, the plasma exhibits variable states, each associated with different impedance levels. To ensure efficient energy transfer and minimize power reflection from the process chamber 104 back to the resonator 110, fine-tuning the frequency for each plasma state may be necessary to maintain the resonator 110 in resonance.

The process chamber 104 is further equipped with a chuck 112 to support a substrate 114. The chuck 112 may be implemented as an electrostatic chuck (ESC) or a vacuum chuck, depending on the process requirements. In a preferred embodiment employing an ESC, the chuck 112 is electrically connected to an RF power generator 116 via a resonator 118. Similar to the resonator 110, the resonator 118 requires tuning to achieve a resonant state by adjusting its operating frequency. It is worth noting that the operating frequencies of the RF power generator 116 may differ from those of the RF power generator 108. For instance, the RF power generator 116 may operate at a substantially lower frequency than the RF power generator 108.

The RF power generator 116 supplies a bias voltage to the chuck 112, typically delivered through a blocking capacitor, which is standard in the field but not shown in the figure. Alternatively, in some embodiments, a tailored waveform generator 117 may be used to provide the bias voltage to the chuck 112. The application of a tailored waveform can significantly narrow the distribution of ion energies, which are generated by the ignition of plasma 128 within the process chamber 104. Depending on the implementation, the tailored waveform generator 117 may be directly connected to the chuck 112 or interfaced with the RF power generator 116.

The RF subsystem, including the RF power generators, resonators, and plasma source, is managed by an RF controller 134, as depicted in FIG. 1B. This controller communicates with and operates under the supervision of a system controller 132. In addition, the process chamber 104 integrates a gas distribution unit 122 responsible for introducing process gases from a gas source 120 into the chamber. The gas distribution unit 122 may take various forms, such as a gas injector, a showerhead, or a side injection system positioned near the chamber's inner surfaces. The gas source 120 is typically connected to the facility's gas supply and uses a combination of valves and mass flow controllers (MFCs) to regulate the flow of gases into the chamber.

The process chamber 104 also includes a pump 124, which may be a turbomolecular pump or another suitable type, to evacuate gases and by-products from the chamber. A vacuum valve 126, generally positioned atop the pump 124, modulates the evacuation rate. Chamber pressure is monitored by a manometer (not illustrated) and controlled by adjusting the position of a movable part of the vacuum valve 126 using an actuator. The position of this movable part corresponds to the setpoint of the vacuum valve 126. The gas distribution subsystem, which encompasses the gas distribution unit 122, gas source 120, pump 124, and vacuum valve 126, is managed by a gas controller 136, as shown in FIG. 1B. The gas controller is also integrated with the system controller 132 to enable coordinated operation of the ALE process system.

In one implementation, the process chamber 104 is sealed on top by a dielectric window 107 to maintain the vacuum required for the ALE process. An opening in the window may accommodate a gas injector for delivering process gases into the chamber. This opening must be carefully sealed to preserve the vacuum integrity of the process chamber 104. If a showerhead is employed, the showerhead itself may serve as the sealing component. The inner surface conditions of the window, showerhead, and injector are known to significantly impact process performance metrics, such as defect counts and etching rates. However, a detailed mechanistic understanding of these effects remains under investigation.

The process chamber 104 further incorporates a temperature control subsystem to maintain the desired thermal conditions within the chamber. As exemplified in FIG. 1A, the temperature of the chuck 112 is regulated by a temperature controller 138, as shown in FIG. 1B, which operates a heater 128 and a chiller 130, along with a temperature sensor (not depicted). The chuck 112 may feature multiple temperature zones, each independently controlled. Additionally, temperature regulation for other chamber components, such as the gas distribution unit 122 and chamber surfaces, may also be necessary and is implemented using standard industry practices.

In state-of-the-art etching process chambers, an edge ring 113 is typically used to modulate plasma, gas flow, and temperature conditions at the edge of the substrate 114. The edge ring 113 can be fabricated from materials such as silicon, quartz, silicon carbide, or ceramics. It may include mechanisms to modulate its operating temperature or electrical potential. As a consumable component, the edge ring's thickness gradually decreases over time due to prolonged exposure to ions and radicals in the plasma 128.

An exemplary ALE process alternates between a surface modification step A and a sputtering step B in a cyclic manner. During step A, chemically active radicals generated in the plasma 128 interact with the substrate surface, modifying it chemically. The plasma is generated by the plasma source 106, powered by the RF power generator 108. Halogen-based gases, such as chlorine, are often used to produce the necessary radicals. During this step, the bias to the chuck 112 is set to zero to minimize ion impact and preserve the integrity of the ALE process.

Conversely, during step B, an inert gas such as argon is introduced to generate energetic ions that physically remove the chemically modified layer through sputtering. At this stage, a bias voltage is typically applied to the chuck 112 using the RF power generator 116, resonator 118, or tailored waveform generator 117, which may be combined for optimal performance. A purge step may be employed between steps A and B to facilitate the transition of gases.

For high aspect ratio (HAR) structures, an additional deposition step C may be included in the ALE cycle sequence at a less frequent rate. This step is designed to protect the sidewalls of etched structures and prevent lateral etching caused by the angular distribution of ions.

FIG. 1B showcases the ALE process system 100A functioning as an autonomous entity, attributed to the advanced capabilities of the system controller 132. This is further detailed in a functional diagram of the autonomous control system, labeled as 100B. The system controller 132 integrates with the RF controller 134, the gas controller 136, and the temperature controller 138, ensuring synchronized operation of these subsystems. A pivotal innovation of the current invention is the incorporation of a system digital twin 140 within the system controller 132. The system digital twin 140 effectively replicates the behavior of the ALE process system 100A, positioning the system controller 132 as an intermediary between the physical system and its virtual counterpart.

Within the system digital twin 140, there are additional components: the RF digital twin 146, the gas digital twin 148, and the temperature digital twin 150, each simulating the operations of their respective subsystems.

The RF digital twin 146 emulates the RF subsystem, including the RF power generators and resonators. Its implementation may involve simulation models such as SPICE models or neural networks trained on a combination of simulated and actual measured data. In some embodiments, a hybrid approach utilizing both models and neural networks is employed for increased accuracy.

The gas digital twin 148 replicates the functions of the gas distribution subsystem, encompassing components such as the gas source 120, the gas distribution unit 122, the pump 124, the vacuum valve 126, and the manometer (not illustrated). This digital twin may utilize fluid dynamics models, analytical models, empirical models, or neural networks trained on both simulated and measured data. Hybrid implementations combining these approaches may also be used.

The temperature digital twin 150 simulates the temperature control subsystem, which includes the heater 128, the chiller 130, and temperature sensors (not illustrated). This digital twin may also account for temperature regulation in other chamber components, such as the gas distribution unit 122. Its implementation may include numerical models, analytical models, neural networks trained on simulated and real data, or a combination of these approaches.

Each subsystem within a specific chamber delivers slightly different outputs due to variations in the subsystem manufacturing process. For real-time process control, the digital twins (146, 148, and 150) must be calibrated periodically to reflect the actual performance of their respective subsystems. Calibration ensures that the digital twins capture any significant drift in subsystem outputs over time.

During plasma processes like the ALE process, the inner surfaces of the process chamber 104 are exposed to energetic ions and radicals for extended periods. Over time, the material thickness of these surfaces may degrade, causing drift in etching parameters, especially around the substrate's edge. It is critical to monitor and quantify such changes within the process chamber. Preventive maintenance procedures can also introduce significant changes in process performance due to conditioning effects on the chamber's inner surfaces.

A chamber surface digital twin 149 is designed to capture changes in chamber surfaces as a function of plasma exposure time, including the effects of preventive maintenance procedures. This digital twin focuses on selected surfaces, such as the inner surfaces of the window, the showerhead, and the injector. Due to the lack of fully established mechanistic models and rapid advancements in plasma-resistant materials, the digital twin 149 may use empirical models, look-up tables, neural networks, analytical models, numerical models, or any combination of these approaches.

A substrate edge digital twin 151 addresses the challenges of achieving consistent performance at the substrate's edge, where plasma, gas flow, and temperature behave differently compared to the central substrate areas. The edge ring 113 is used to modulate process performance at the edge, but its thickness decreases over time due to prolonged plasma exposure. The digital twin 151 may incorporate empirical models, look-up tables, neural networks, analytical models, numerical models, or a combination of these methods to account for these edge-specific effects.

The chamber plasma digital twin 152 simulates the internal plasma dynamics within the process chamber 104. It incorporates input from other digital twins (146, 148, 150, 149, and 151) to create a comprehensive model of electron, ion, and neutral particle behavior. This model may represent particle distributions in three dimensions or as a simplified two-dimensional version, either continuously over time or as discrete snapshots. It characterizes properties such as particle energy, velocity, and density.

For instance, in a scenario using an ICP plasma source, RF power from the RF generator 108 via the resonator 110 generates an electromagnetic field that creates electrons near the ICP source. These electrons interact with the field to produce ions and neutral particles, a process well-established in the field. The digital twin 152 can simulate the formation of the plasma sheath near the substrate and the inner surfaces of the chamber, accounting for historical particle distributions influenced by real-time controls such as frequency adjustments, pressure regulation, and temperature management.

The chamber plasma digital twin 152 may employ sophisticated numerical models requiring significant computational resources. To improve efficiency, a neural network trained on numerical modeling outputs may be used. Real-world measurements, such as magnetic field distributions recorded using B-dot probes or electron density measurements from hairpin probes, can enhance the neural network's predictive accuracy. In some implementations, analytical models may supplement numerical and neural network-based approaches.

Understanding the behavior of particles within the ALE process system is crucial for modeling ion and neutral fluxes to the substrate surface. The plasma sheath's properties, pivotal for accurate flux calculations, are integral to these models. These fluxes, essential for the ALE process, may also be measured with specialized apparatus to further refine neural network training data.

The digital twins—including the RF digital twin 146, the gas digital twin 148, the temperature digital twin 150, and the chamber plasma digital twin 152—form the reactor digital twin 154. The chamber surface digital twin 149 and the substrate edge digital twin 151 enhance accuracy by capturing the effects of “drift” caused by plasma exposure on chamber components. This integrated digital twin provides critical outputs, including ion and neutral fluxes to the substrate surface, temperature distributions, and bonding distributions, enabling precise real-time process control.

The overarching system digital twin 140 extends to include the process digital twin 156, which uses ALE as an example. The process digital twin 156 integrates outputs from the reactor digital twin 154 to simulate the evolution of substrate structures during the ALE process. It inputs data on substrate characteristics such as mask layers, thickness, material properties, dimensions, and profiles of structures, as well as the properties of the target layer for etching.

Beyond this, the ALE digital twin 156 processes recipe parameters like the durations for steps A and B, the total ALE cycle count, insertion points and durations for step C, along with any pulse modulation specifics such as pulse duration and duty cycles, if applied within the ALE steps. Other parameters, particularly those related to subsystems like RF power settings, are already encompassed by the respective digital twins (146, 148, 150). It should be noted that there are many variations in implementing an ALE process. For example, the step C is optional and may not be used for certain applications like etching a film with a thickness less than 100 nm. There are also many variations in implementing pulse schemes for the plasma source and the bias. All such variations fall into the present inventive concept.

For implementation purposes, while a Monte Carlo simulator or other numerical simulators might provide high accuracy, they often demand considerable computational resources, which can be a drawback for real-time applications. An alternative approach involves deploying a neural network within the ALE digital twin 156. Initial training with simulated data followed by subsequent refinement using empirical data ensures a robust, responsive system. In some implementations, the ALE digital twin 156 may be developed as a hybrid, employing both analytical and numerical models or combining analytical models with neural networks. The self-limiting behavior of the ALE process lends itself well to analytical modeling, efficiently capturing fundamental ALE responses. Numerical models or neural networks can be incorporated to address deviations from the ideal process, like lateral etching or depth loading effects. This synergy between models enhances the precision of predictions while maintaining computational efficiency.

The system controller 132 is additionally equipped with a measurement engine 142 and a recipe generator 144, both of which synergistically collaborate to autonomously generate an ALE process recipe, along with the parameters for subsystem control. The measurement engine 142 is specially designed to capture real-time data. For example, optical critical dimension (CD) data can be collected by optical sensors in real-time to gauge the structure progression under the ALE process at a particular step. Furthermore, subsystem control parameters can deviate from targeted ones because of variations and drifts in the subsystem components. The measurement engine 142 may capture the subsystem parameters in real-time and consequently improve the prediction accuracy of the digital twins.

The recipe generator 144 can be used to design a process recipe prior the substrate is loaded onto the chuck for processing. The recipe generator 144 can also take the outputs of the measurement engine 142 in real time and apply the system digital twin 140 to adjust recipe and subsystem control parameters for the remaining steps of the ALE process.

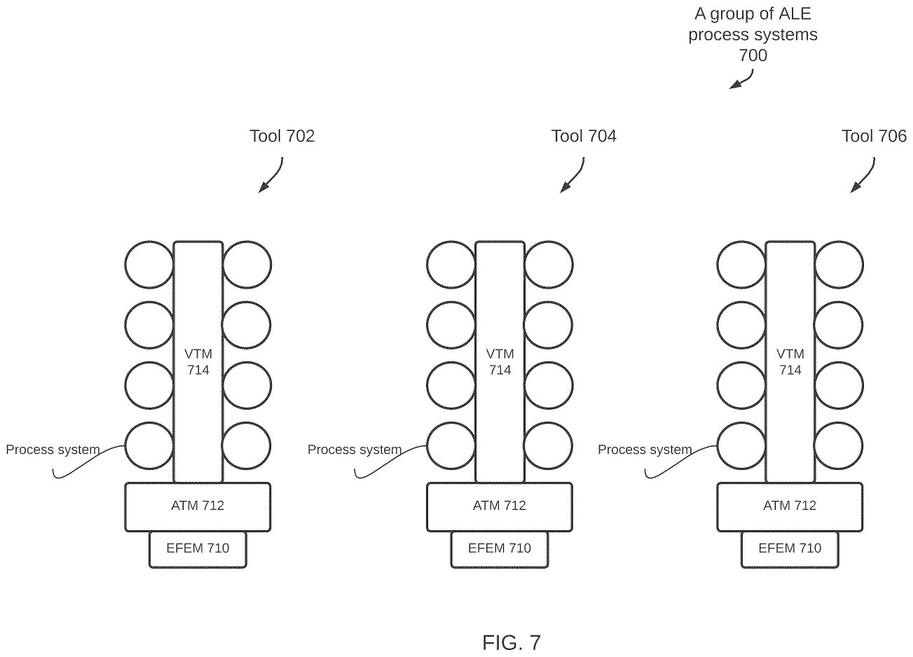

The system controller 132 is further connected to a tool controller 160 and a group controller 162. A schematic diagram of a group of process systems installed at different tools (702, 704, and 706) is depicted in FIG. 7. Three tools are illustrated as an example. There may be many tools to form a group of chambers. Each tool may include a tool level controller (160). The group of the tools may have a centralized controller (162). Each tool further includes an equipment front end module (EFEM) 710, an atmosphere transfer module 712, and a vacuum transfer module 714.

Detailed descriptions of various embodiments will be elucidated in the subsequent paragraphs of this disclosure. Across all embodiments, digital twins are utilized to enhance the system's performance. In certain embodiments, advanced optimization procedures are applied to initially formulate the recipe and the subsystem control parameters, which are then subjected to iterative optimization.

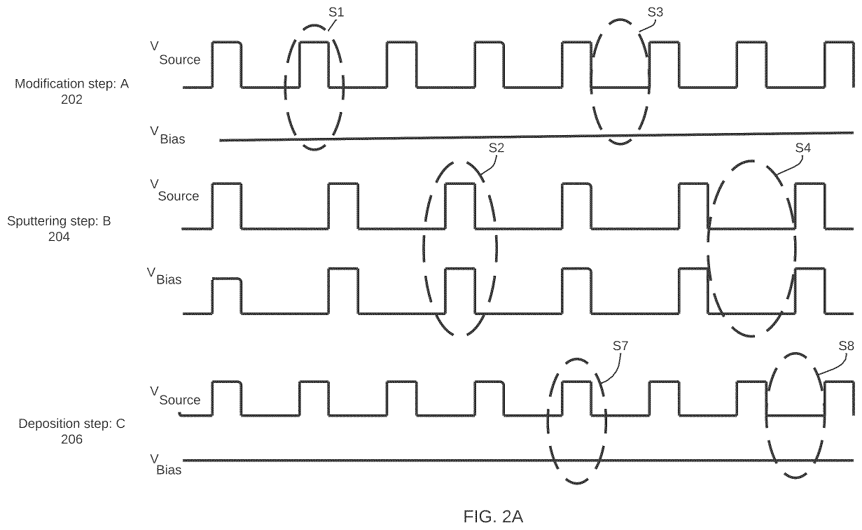

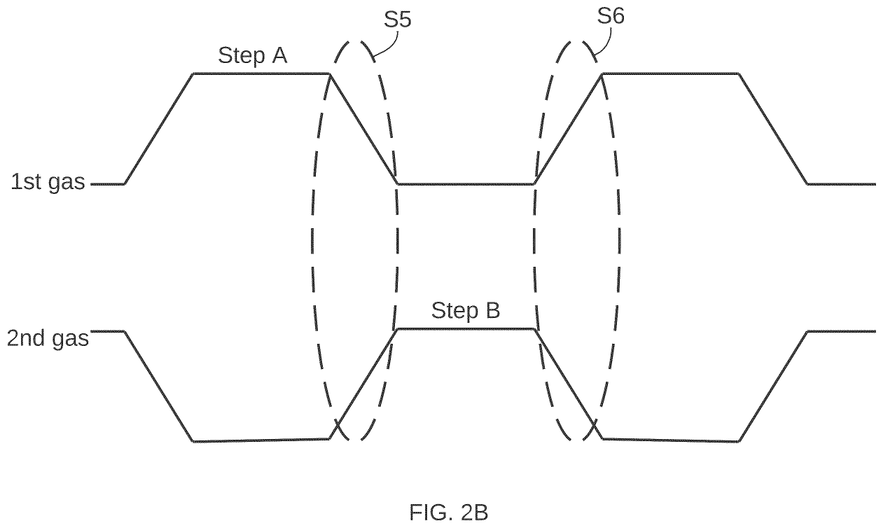

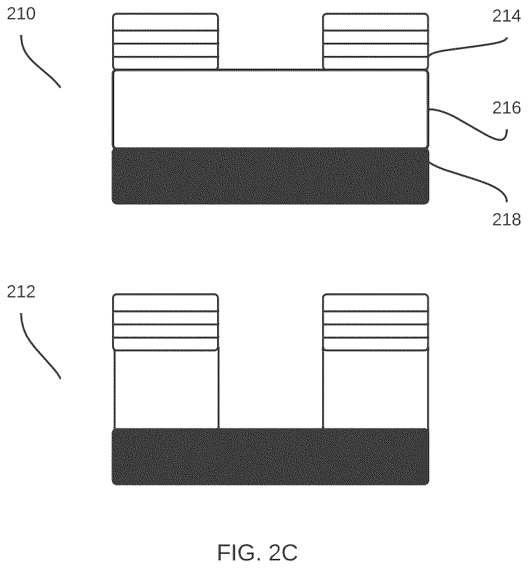

FIG. 2A depicts various states in steps A, B, and C. State S₁ represents a state in the surface modification step A 202, where the plasma source 106 receives RF power from the RF power generator 108, while the bias voltage for the chuck 112 is set to be zero. This state is crucial for enabling surface modifications without a chuck bias, thereby avoiding energetic ions impacting the substrate surface. State S₂ reflects a state in the sputtering step B 204, where the chuck is biased by either the RF power generator 116 and/or the tailored waveform generator 117. This bias voltage is essential for the sputtering process as it directs the energy and trajectory of ions toward the substrate.

State S₃ captures another state within the surface modification step 202, where both the plasma source 106 and the chuck 112 cease to receive RF power. This state remains significant as radicals generated during S₁ continue to modify the substrate surface. State S₄ illustrates a state in the sputtering step B 204, wherein both the bias and the source are turned off. This state can be significant for allowing byproducts to diffuse out of a high aspect ratio (HAR) structure.

States S₇ and S₈ pertain to the deposition step C 206. State S₇ is used to generate ions and neutrals for deposition, while state S₈ allows the generated neutrals to diffuse into desired positions within the HAR structure. These states facilitate the deposition of a layer to protect the sidewalls of structures being etched during the ALE process.

FIG. 2B showcases an exemplary ALE process utilizing the process system 100, including transitions between process gases. During state S₅, the first gas for the modification step 202 is ramped down, and the second gas for the sputtering step is ramped up. This transition is critical for switching between the two distinct steps (A and B) of the ALE process. Conversely, state S₆ represents the ramping up of the first gas for the surface modification step A 202 and the ramping down of the second gas for the sputtering step B 204, marking the preparation for a return to the modification step.

FIG. 2C illustrates an exemplary incoming structure 210 and a structure 212 post-ALE process. The incoming substrate 210 includes a mask layer 214, a targeted layer 216 to be etched by the ALE process, and a layer 218 underneath the targeted layer. As shown in Table 1, the dataset describing the incoming mask includes, but is not limited to, materials for the mask stack, thickness, mask dimensions, profile, uniformity, and loading created from previous process steps. In some implementations, the mask stack is a photoresist layer. In other implementations, the mask layer may be a hard mask, such as a carbon layer, silicon oxide layer, silicon nitride layer, or a combination thereof. These properties need to be disclosed to enable the ALE digital twin. The dataset also includes information about the targeted layer 216, such as material properties, thickness, and the characteristics of the underlying material, which may affect the profile near the bottom of the structure post-ALE.

As further detailed in Table 1, parameters describing the structure post-ALE 212 include dimensions, profile, uniformity, and loading. The profile may be characterized by parameters such as top and bottom dimensions, bowing, and the position of bowing. Loading includes the isolation-to-dense pattern dimension and depth differences post-ALE process.

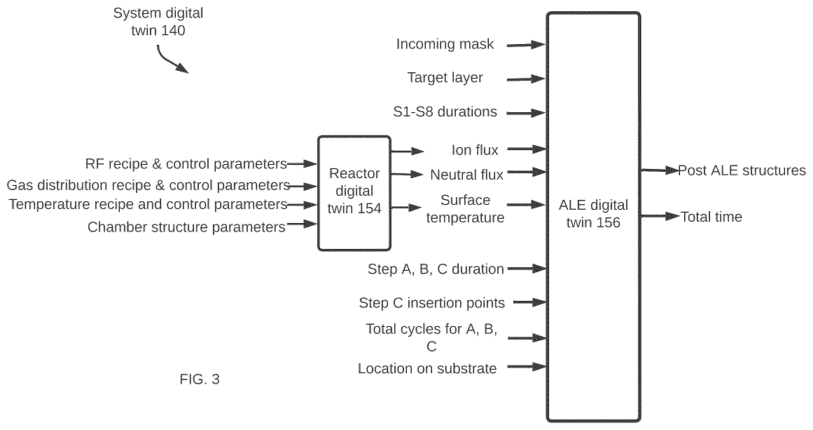

FIG. 3 provides a schematic overview of the system digital twin 140 for the ALE system 100, offering a comprehensive digital representation of the physical ALE process. The system digital twin 140 includes the reactor digital twin 154, which assimilates various subsystem parameters and chamber structure parameters into its computational framework. These inputs are essential for accurately simulating the physical interactions and phenomena occurring within the ALE reactor. Recipe parameters are also incorporated to predict plasma performance in the process chamber 104.

The reactor digital twin 154 outputs detailed predictions of ion and neutral fluxes, as well as substrate surface temperature. These outputs serve as key inputs to the ALE process digital twin 156, bridging subsystem parameters with process outcomes. The ALE process digital twin 156 further incorporates parameters specific to the ALE process, including mask parameters for the incoming substrate and parameters for specific layers targeted for the ALE process, as shown in Table 1. Additionally, it integrates detailed ALE recipe parameters, such as the duration of specific states (S₁ to S₈) durations of steps A through C, insertion points for step C, and the total number of cycles for each step, as shown in Table 2. Spatial data pinpointing the locations of structures to be processed on the substrate is also included. These inputs enable the ALE process digital twin 156 to project outputs, including the characteristics of post-ALE process structures (as shown in Table 1) and the overall processing time for the ALE cycle.

For implementation, the ALE process digital twin 156 may utilize a model-based approach, a neural network, or a hybrid of both, depending on the complexity of the ALE process, the need for real-time feedback, and prediction accuracy requirements. Neural networks, if employed, can leverage the foundation provided by the system digital twin, using computational techniques such as Monte Carlo simulations or numerical models. The simulation data generated by the system digital twin 140 can be used to train the neural network, with additional real-world measurements validating and refining the simulated data to enhance robustness and reliability.

This digital twin framework provides a virtual yet precise reflection of the ALE process, enabling improved understanding, control, and optimization of the complex interactions and parameters that govern ALE system performance.

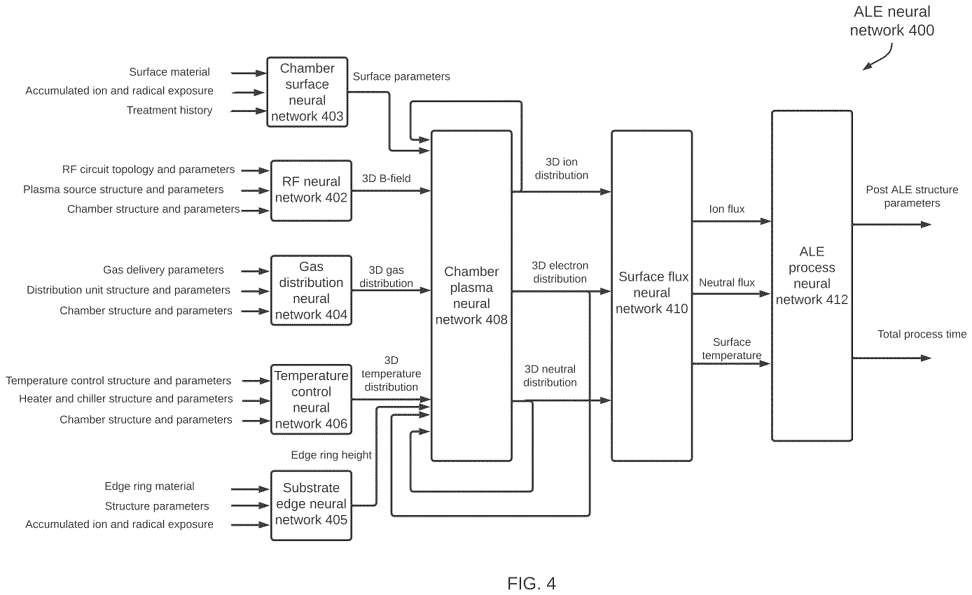

FIG. 4 illustrates an exemplary process system represented as a neural network 400, where the subsystems are captured using various neural networks. For example, the RF digital twin 146 forms the basis for training the RF neural network 402. Taking the plasma source 106 attached to the RF power generator 108 and resonator 110 as an example, a SPICE model can simulate the generator, resonator, and their transmission lines. This SPICE model provides initial AC current and voltage data for the plasma source coils 106, assuming an initial plasma impedance. A numerical simulator then applies Maxwell's equations to predict the electromagnetic field distribution within the process chamber 104.

The simulation data generated by the RF digital twin 146 is used as a training set for the RF neural network 402. Inputs to the neural network include RF circuit topology and parameters such as the values of inductors, capacitors, resistors, and transistors in the generator and resonator, along with effects from transmission lines. Additional parameters, such as the size, position, resistivity, and coil turn count of the plasma source, are incorporated into the training process. The RF neural network 402 also considers chamber structure parameters, including dimensions, positions of the chuck and window, and material properties. Some parameters, measurable through sensors, are assigned greater weight during training. For instance, sensors may monitor current and voltage changes in the coils or measure reflected power at the resonator's output node 110. A B-dot sensor with multiple small coils could be positioned in the chamber to map the magnetic field distribution, ensuring that the RF neural network 402 aligns closely with observed physical behaviors.

Modeling the bias portion of the RF subsystem using a neural network focuses on the electric field initially generated in response to applied RF power. Unlike the magnetic field related to plasma generation, the bias pertains to the electric field's effects on the substrate surface.

Transitioning to the gas dynamics within the system, we examine the gas distribution neural network 404, which is derived from the gas digital twin 148. Numerical fluid dynamics forms the foundation for determining the gas distribution within the process chamber 104. This interplay involves the gas inflow from the gas distribution unit 122, the outflow managed by the pump 124 and the vacuum valve 126 and is influenced by the chamber's conductance and volumetric parameters. While numerical simulations provide accuracy, their computational intensity and time constraints necessitate a more efficient approach for real-time applications, leading to the development of the gas distribution neural network 404.

The gas distribution neural network 404 is trained on simulation data incorporating parameters such as the types and flow rates of gases, the design of the gas distribution unit 122, the pump's capacity 124, the position of the movable part of the vacuum valve 126, and the chamber dimensions and conductance. The position of the movable part is controlled by the setpoint of the vacuum valve 126. The gas distribution unit 122, implemented as an injector, a showerhead, or a combination of both, significantly affects gas distribution within the process chamber 104. Key design parameters include the size, quantity, and distribution of channels in the injector and the showerhead. Gas pressure within the process chamber, monitored by a manometer, provides real-world data that enhances the training of the gas distribution neural network 404. This measured data often carries more weight than simulation data to ensure the model's accuracy under actual conditions.

The temperature control neural network 406, derived from the temperature digital twin 150, maps the thermal landscape within the chamber, particularly at the substrate surface. Training for the temperature control neural network 406 originates from numerical models simulating heat interactions and distributions. Inputs include chuck and chamber parameters that affect thermal conduction. In scenarios utilizing an electrostatic chuck (ESC), the thermal properties of the ESC and the efficiency of heat conduction, influenced by helium pressure as a medium, are critical. Setpoints for heating and cooling elements, such as the heater 128 and chiller 130, and chamber specifications, including size and construction materials, are also integral inputs. Temperature readings from sensors positioned in the chuck 112 and chamber 104 provide real-world data, which may carry greater weight in training to closely mimic the physical environment. This combination of simulated and measured data ensures the neural network's predictions are highly accurate and applicable to the ALE process system.

The inner surfaces of the chamber, such as the window, gas injector, and showerhead, are subject to degradation over time due to plasma exposure. The chamber surface neural network 403 models these “memory” effects, drawing inputs such as surface material, accumulated ion and radical exposure, and treatment histories. Outputs include surface parameters like structure, composition, roughness, and sticking coefficient, which collectively influence chamber radical and ion distributions. Training data for the chamber surface neural network 403 originates from the chamber surface digital twin 149 and can be augmented with measured data obtained from specially designed testing apparatus. This neural network mimics the digital twin with significantly improved computational efficiency.

Consumable parts in the process chamber 104, such as the edge ring, experience dimensional changes due to prolonged plasma exposure. For instance, a reduction in edge ring thickness can substantially affect process performance at the substrate's edge. The substrate edge neural network 405 mimics the substrate edge digital twin 151, achieving greater computational efficiency. Input parameters include the edge ring material, structural parameters such as initial height, and exposure history to ions and radicals in the plasma. Outputs include the remaining height of the edge ring. In some implementations, the temperature and electrical potential at the edge may also serve as inputs to predict the edge ring erosion rate or outputs for the chamber plasma digital twin or neural network.

FIG. 4 illustrates further an ALE reactor where the outputs of subsystem neural networks serve as inputs to the chamber plasma neural network 408. This network, based on the chamber plasma digital twin 152, provides a sophisticated representation of the plasma dynamics within the etching chamber. Simulating particle movements within the plasma involves either Monte Carlo methods or numerical plasma simulators to visualize the three-dimensional distributions of electrons, ions, and neutrals. The lighter electrons move faster than ions, forming a plasma sheath on chamber surfaces. This sheath accelerates ions toward the substrate, a critical aspect for sputtering but potentially disruptive during surface modification.

The chamber plasma neural network 408 integrates simulation data for rapid and efficient computation. Measured data from chamber sensors, such as optical sensors detecting light emission from neutrals and hairpin sensors gauging electron density, refine the network's predictive capabilities. Measured data is weighted more heavily than simulated data to align outputs with actual system behavior.

The chamber plasma neural network 408 employs a recurrent neural network (RNN) design, allowing it to process temporal sequences. This design enables the network to incorporate snapshots of plasma conditions into future predictions, reflecting the dynamic evolution of the plasma state. Once the network computes three-dimensional distributions, ion and neutral fluxes to the substrate surface are determined using the surface flux neural network 410. These fluxes, along with substrate surface temperature, are inputs for the ALE process neural network 412.

The ALE process neural network 412, trained on data from the ALE digital twin, provides outputs such as post-ALE structure parameters (listed in Table 1) and total process time. Together, the chamber plasma neural network 408 and surface flux neural network 410 generate valuable insights beyond fluxes, including surface temperature and chemical bonding distributions. These outputs are critical for fine-tuning the ALE process to achieve precise etching and high-quality substrate surfaces.

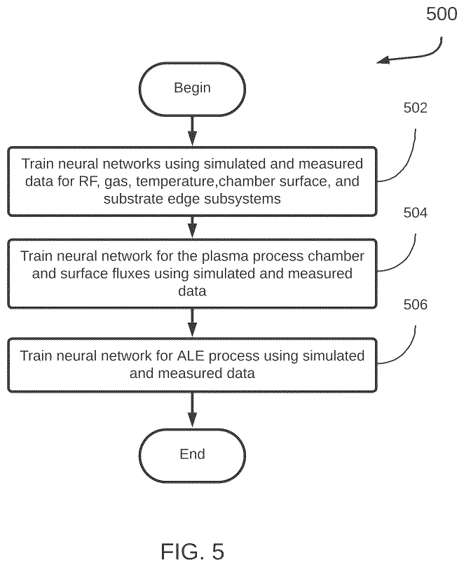

FIG. 5 presents a flowchart outlining the methodology for training the ALE neural network 400. The process 500 begins at step 502, where the subsystem neural networks (402, 404, 406, 403, and 405) are trained using simulated data. Following this, at step 504, the neural network 408/410 is trained utilizing simulated data. In step 506, the ALE process neural network 412 is trained with simulated data, including the outputs from steps 502 and 504. The training regimen for each neural network is further refined by incorporating measured data related to the subsystems, the plasma chamber, and the ALE process itself. Techniques to increase the weight of measured data include constructing a cost function with higher weights assigned to measured data or reusing measured data with artificially added low-level noise to enhance robustness.

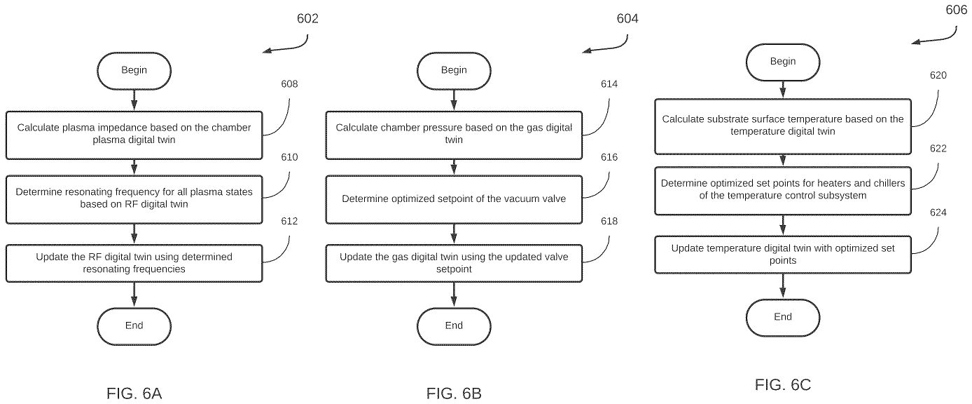

FIG. 6A depicts a procedural flowchart for identifying resonant frequencies corresponding to plasma states, each characterized by a unique plasma impedance in the ALE process. The process 602 starts at step 608, where plasma impedances are computed using the chamber plasma digital twin 152. At step 610, resonant frequencies for the various plasma states are determined based on the RF digital twin 146. In step 612, the RF digital twin 146 is updated to reflect the newly determined resonant frequencies.

FIG. 6B sets forth a flowchart delineating the procedure for establishing the position of the movable part of the vacuum valve according to the gas digital twin 148. The process 604 begins at step 614, where the chamber pressure is calculated using the gas digital twin 148 based on an initial position of the movable part. Step 616 involves determining the optimized position of the movable part to achieve the desired chamber pressure. Finally, the gas digital twin 148 is updated in step 618 to integrate the optimized position or associated setpoint.

FIG. 6C illustrates a flowchart detailing the procedure for defining setpoints for a heater and a chiller. The process 606 starts with step 620, where the substrate surface temperature is computed by the temperature digital twin 150 using initial setpoints for the heater 128 and the chiller 130. In step 622, optimized setpoints are determined to maintain the substrate temperature within the desired range, utilizing the temperature digital twin 150. Step 624 updates the temperature digital twin 150 to include the optimized setpoints.

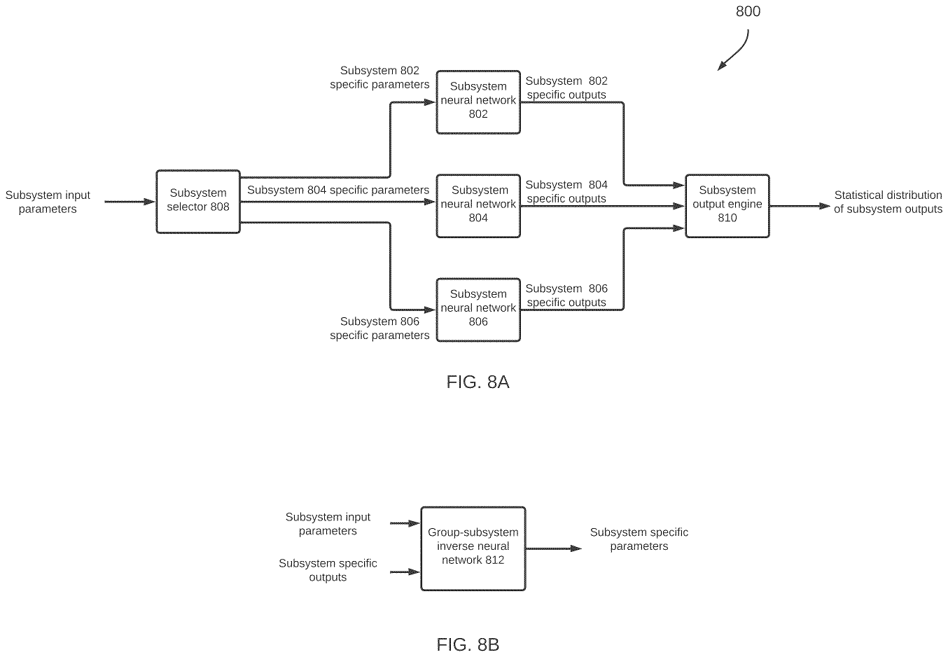

FIG. 8A showcases an embodiment of a group-subsystem digital twin, designated as 800. This digital twin 800 exemplarily includes subsystem neural networks 802, 804, and 806. In a typical group-subsystem digital twin, numerous subsystem neural networks are present. These neural networks are connected to the output of a subsystem selector 808. The subsystem selector 808 is configured to receive subsystem input parameters and select one neural network from the available ones for each simulation. This selection process is facilitated by a random number generator controlled by the group controller 162. In a specific implementation, each neural network is assigned an equal probability of selection. Once selected by the subsystem selector 808, the chosen subsystem neural network processes the subsystem-specific parameters along with the subsystem input parameters to generate the subsystem-specific outputs.

To illustrate the inventive concept, consider an RF subsystem as an example. For an exemplary RF subsystem, the subsystem-specific parameters might include values of the components for RF circuits, which can vary across different RF subsystems. Additional RF subsystem-specific parameters might include coil parameters for the plasma source. These parameters could be determined during the manufacturing process of the subsystem or during its post-integration into a chamber. The RF subsystem's outputs may encompass current, voltage, and phase delivered to a chamber's plasma source, as generated by a SPICE model based simulation or measured by respective sensors. The outputs may also include resonant frequency. Additionally, reflected power at a specific operating frequency, detected by directional couplers placed at the output of the RF power generator, might be among the outputs.

Multiple simulations can be executed, and their outputs are processed by the subsystem output engine 810. When a large number of simulations is conducted, the digital twin generates a statistical distribution of the subsystem outputs. The generated statistical distributions can be stored in a database.

FIG. 8B depicts a group-subsystem inverse neural network, designated as 812. This inverse neural network utilizes subsystem input parameters and subsystem-specific outputs as its inputs and subsystem-specific parameters as its outputs. It is trained by retrieving the data from the database, which constitutes the statistical distribution. Once the training is completed, the inverse neural network 812 can infer new subsystem-specific parameters by using the measured data of the subsystem outputs.

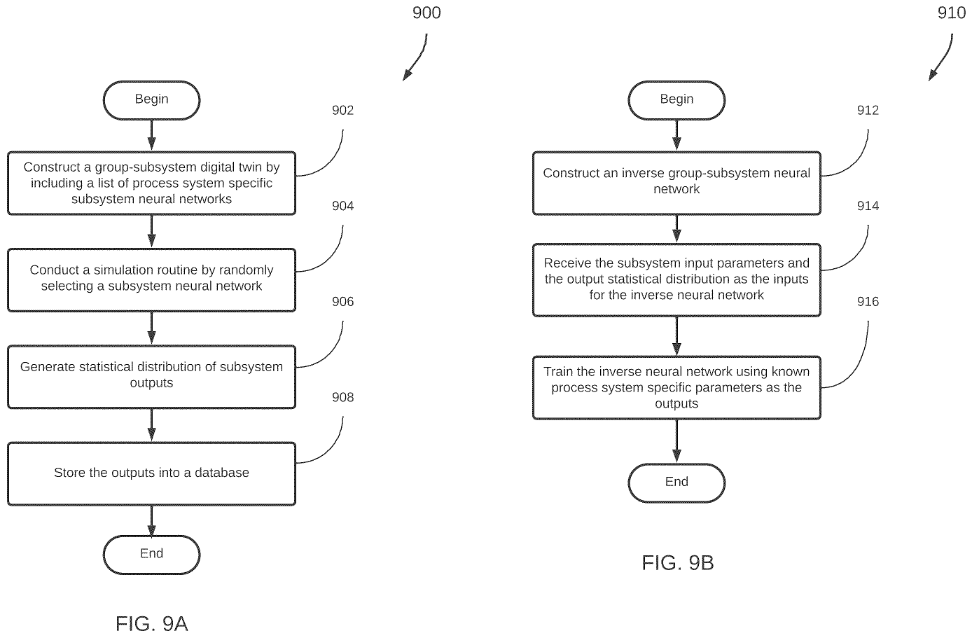

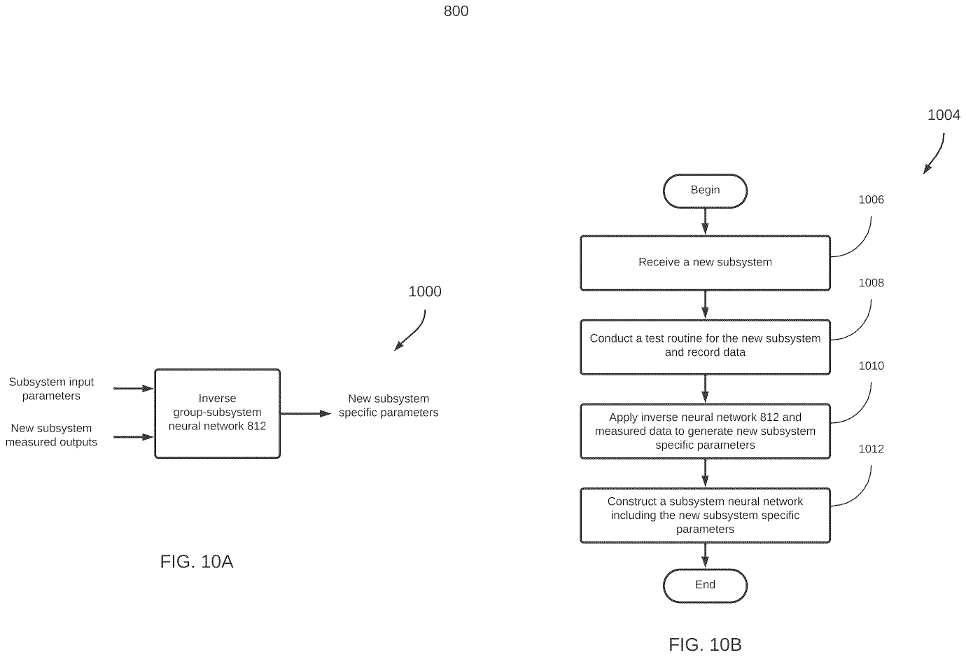

FIG. 9A illustrates a flowchart for process 900, designed to record simulated statistical distributions of subsystem outputs in a database. Process 900 begins with step 902, where a group-subsystem digital twin 800 is constructed, incorporating various subsystem-specific neural networks. At step 904, a simulation routine is executed, often repeatedly, to produce statistically significant subsystem outputs. Each simulation involves selecting one subsystem neural network using the random number generator. Step 906 generates subsystem-specific outputs, typically through neural network inference. At step 908, these outputs, along with the subsystem input parameters and subsystem-specific parameters, are stored in a database with an appropriate data structure for future use.

FIG. 9B presents a flowchart for process 910, which details the construction of an inverse group-subsystem neural network 812. Process 910 begins with step 912, where the inverse neural network 812 is established by assigning initial weights. At step 914, the data stored in the database is retrieved to provide subsystem inputs, outputs, and associated subsystem-specific parameters. The inverse neural network is trained by leveraging the data in step 916. After the completion of the training, the inverse neural network 812 can infer the subsystem-specific parameters for a new subsystem using the subsystem inputs and the measured subsystem outputs.

FIG. 10A depicts a schematic of an inverse subsystem neural network 812 applied to a new process system. The trained inverse neural network 812, operating in inference mode, accepts subsystem input parameters and newly measured subsystem outputs as inputs, generating new subsystem-specific parameters as outputs.

FIG. 10B presents a flowchart illustrating process 1004, designed to construct a subsystem neural network for a new subsystem. Process 1004 begins with step 1006, where a new subsystem is introduced. In step 1008, a measurement routine is conducted on the subsystem, with data captured and recorded. At step 1010, the measurement results, combined with the subsystem input parameters, are fed into the inverse neural network 1002 to generate new subsystem-specific parameters. Subsequently, at step 1012, a new subsystem neural network is created. It is important to note that the term “new subsystem” refers to a completely new subsystem, a refurbished subsystem, or a subsystem that has undergone preventive maintenance.

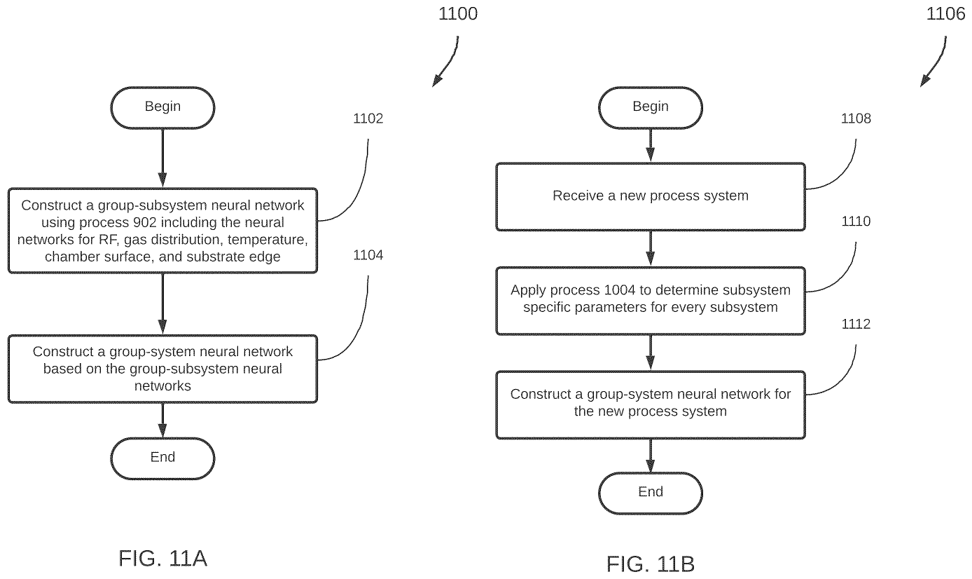

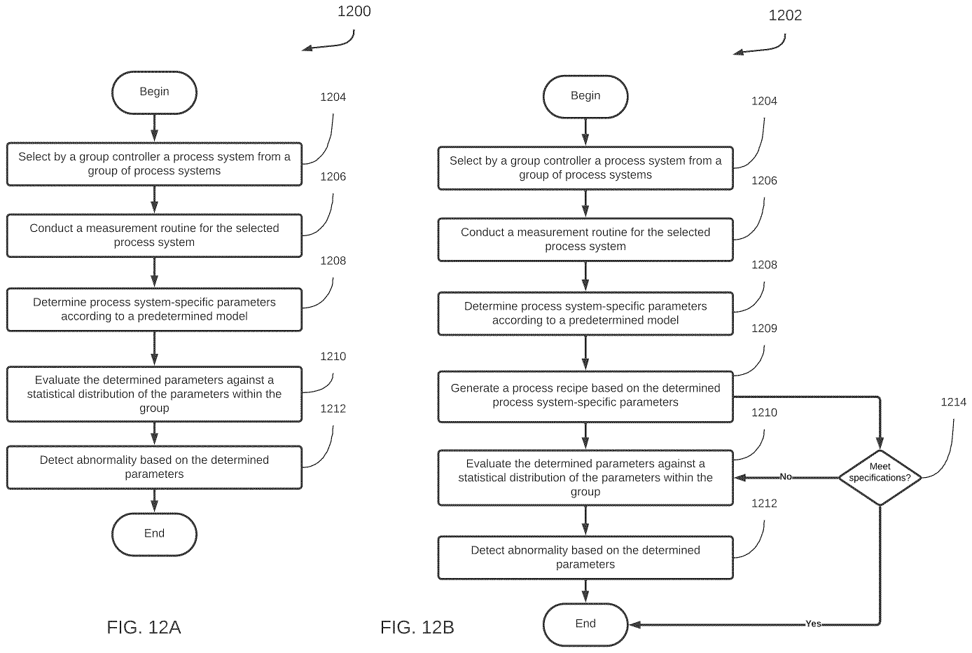

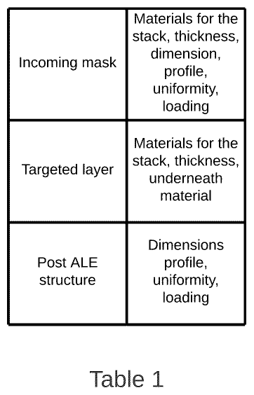

FIG. 11A illustrates a flowchart for generating an ALE neural network representing the operations of a group of ALE process systems. Process 1100 begins with step 1102, where a group-subsystem neural network is generated for each subsystem, including but not limited to the RF subsystem, gas distribution subsystem, temperature control subsystem, chamber surface subsystem, and substrate edge subsystem. At step 1104, the ALE neural network for the group of ALE systems is generated, drawing upon these group-subsystem neural networks.

FIG. 11B depicts a flowchart for process 1106, focusing on generating an ALE neural network for a new process system. Process 1106 starts with step 1108, where a new ALE process system is introduced. At step 1110, process 1004 is executed to determine the new process system-specific subsystem parameters for all identified subsystems. Following this, at step 1112, the ALE neural network is constructed based on the process system-specific subsystem neural networks. It is worth noting that the new process system can also be a system that has undergone preventive maintenance. After replacing consumable parts and cleaning the interior chamber surfaces, the process system often exhibits significantly altered behavior.

It should be emphasized that the ALE process system is presented here as an illustrative example of the inventive concept. The scope of this invention is not limited to ALE process systems and can be seamlessly adapted to various other plasma process systems and thermal process systems, as discussed in previous sections.

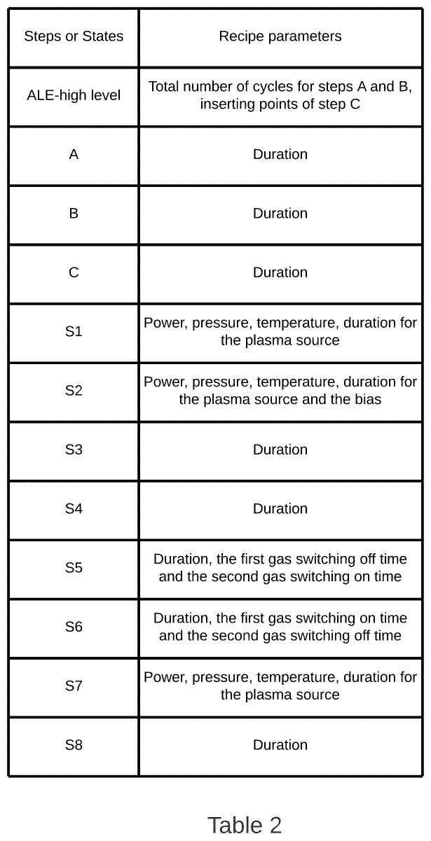

FIG. 12A depicts a process for a first embodiment of a process for determining if a selected process system exhibits abnormalities. Process 1200 starts with step 1204 that a process system is selected by the group controller 162 for evaluation. The process system maybe a new one after completion of the installation procedure in a manufacturing site. The process system may have demonstrated abnormal behaviors detected by the measurement engine. In step 1206, a measurement routine is conducted by the system controller 132 of the selected process system. The measurement maybe focused on one of the subsystems or all of the subsystems. In step 1208, process system-specific parameters maybe determined based on a predetermined model. In one implementation, the predetermined model is one or several inverse neural networks, depending on the measurement routine. In step 1210, the group controller 162 evaluates the determined parameters against the statistical distribution of the parameters within the group. The statistical distribution is retrieved from a database.

The group controller 162 calculates the value of a predetermined deviation function using the new process system-specific parameters and the statistical distribution of prior data. The deviation function can be expressed as follows:

$$Dev = {\sum }_{i = 1}^{N} {{W}_{i} ( {P}_{i} - {P}_{inom} )}^{2} ,$$

where Dev is the deviation, Wᵢ is the weight, and Pᵢ is the process system-specific parameter, Pᵢₙₒₘ is the nominal value of the parameter, and N is the number of the parameters. At step 1210, the calculated deviation is compared to a target value. If the deviation fails to meet the target, at step 1212, problematic parameters are identified. The problematic parameters can be identified by looking into a distance between the parameters and the nominal values by taking account the weighting factor.

FIG. 12B depicts a second embodiment of the process for detecting the abnormalities, denoted as 1202. The difference between 1200 and 1202 lies on an addition of step 1209 where a process recipe is generated autonomously by the recipe generator 144 based on the determined process system-specific parameters. In one implementation, the recipe is generated by the system controller 132 through an optimization procedure. For an ALE process, the incoming substrate parameters are received by the system controller as listed in Table 1. A cost function is minimized by the optimization procedure to determine recipe and subsystem control parameters. The cost function can be constructed as a least squared error function of the simulated and targeted outputs of one or more structures being etched. In step 1214, if the recipe can be generated which meets the output specifications, the process 1202 concludes. Otherwise, steps 1210 and 1212 are conducted to nail down the problematic parameters.

The ALE process system is used here to illustrate the inventive concept. However, the process systems covered by this invention include, but are not limited to, an ALE process system, a reactive ion etching (RIE) process system, a plasma-enhanced chemical vapor deposition (PECVD) process system, and an atomic layer deposition (ALD) process system.

1. A method for detecting abnormality within a group of process systems, comprising:
selecting, by a group controller, a process system from a group of process systems, wherein the selected process system is represented by a process system-specific digital twin and the group of process systems is represented by a group system digital twin;
conducting a measurement routine for the selected process system;
determining process system-specific parameters according to a predetermined model;
evaluating the determined parameters against a statistical distribution of the parameters within the group; and
detecting abnormality based on the determined parameters.

2. The method of claim 1, further including generating a recipe and subsystem control parameters using the process system-specific digital twin through an optimization procedure based on the determined parameters.

3. The method of claim 2, wherein the abnormality is further determined by evaluating the outcome of the recipe against specified output requirements.

4. The method of claim 1, wherein the process system-specific parameters are determined by utilizing inverse neural networks for the subsystems, which are trained using simulation data generated by group subsystem digital twins.

5. The method of claim 4, wherein the inverse neural network accepts measured data from the measurement routine and input parameters for the subsystems as inputs.

6. The method of claim 1, wherein the process system-specific digital twin includes neural networks trained for individual subsystems.

7. The method of claim 6, wherein the subsystems include an RF subsystem, a gas distribution subsystem, and a temperature control subsystem.

8. The method of claim 7, wherein the subsystem-specific neural network includes models for capturing plasma induced aging effects on selected chamber surfaces and the substrate edge.

9. The method of claim 4, wherein the group subsystem digital twin includes a collection of subsystem specific digital twins, and a specific subsystem is selected using a random number generator during a simulation.

10. The method of claim 1, wherein the process systems includes one of the following: an ALE process system, a reactive ion etching process system, a plasma-assisted chemical vapor deposition process system, and an atomic layer deposition process system.

11. A semiconductor manufacturing process system in a group of the process systems, comprising:
an RF subsystem, a gas delivery subsystem, and a temperature control subsystem;
a system controller comprising a system digital twin, including digital twins for the subsystems, a chamber plasma digital twin, and a process digital twin, a measurement engine; and a recipe generator;
a group controller, including a group system digital twin and group subsystem digital twins; and
wherein the system controller is operated in collaboration with the group controller to identify abnormalities in the process system through an autonomous recipe generation procedure based on the digital twins.

12. The system of claim 11, wherein the recipe is generated autonomously by the system controller or the group controller through an optimization procedure.

13. The system of claim 11, wherein the abnormalities are further identified based on generated subsystem-specific parameters by leveraging inverse neural networks for the subsystems.

14. The system of claim 13, wherein the inverse neural networks utilize measured data from the measurement engine and input parameters for the subsystems as inputs.

15. The system of claim 14, wherein the inverse neural network is trained using simulated data generated from the group subsystem digital twins.

16. The system of claim 15, wherein the abnormalities are detected by analyzing subsystem-specific parameters determined by the inverse neural network.

17. The system of claim 11, wherein the digital twins are represented by neural networks trained using simulated data by the digital twins.

18. The system of claim 11, the system digital twin includes models accounting for modeling plasma induced aging effects on selected chamber surfaces and the substrate edge.

19. The system of claim 11, wherein the group subsystem digital twin includes a collection of subsystem-specific digital twins, and a specific subsystem system is selected using a random number generator during a simulation.

20. The system of claim 11, wherein the process systems includes one of the following: an ALE process system, a reactive ion etching process system, a plasma-assisted chemical vapor deposition process system, and an atomic layer deposition process system.
